(19) United States
(12) Patent Application Publication
(10) Pub. No.: US 2026/0091519 A1
(43) Pub. Date: Apr. 2, 2026

(54) RETURN DEVICE FOR RETURNING AT LEAST ONE LINE

(71) Applicant: Dürr Systems AG, Bietigheim-Bissingen (DE)

(72) Inventor: Andreas Collmer, Vaihingen/Enz (DE)

(21) Appl. No.: 19/112,116

(22) PCT Filed: Sep. 12, 2023
(86) PCT No.: PCT/EP2023/074959

§ 371 Date: Mar. 17, 2025

(30) Foreign Application Priority Data
Sep. 15, 2022 (DE) 10 2022 123 623.4

(51) Int. Cl. B25J 19/00; F16L 3/015; H02G 3/04

(52) U.S. Cl. CPC B25J 19/0025; F16L 3/015; H02G 3/0456

(57) ABSTRACT

A return device for returning at least one line, having an elongated return element for returning the at least one line, a mounting device for mounting the return element, at an articulated arm robot, and a guiding device for guiding the at least one line. The return device stands out in particular by the fact that the return element is designed as an elastic swing element. The disclosure also concerns an articulated arm robot having such a return device.

### CROSS-REFERENCE TO RELATED APPLICATIONS

This application is a national stage of, and claims priority to, Patent Cooperation Treaty Application No. PCT/EP2023/074959, filed on Sep. 12, 2023, which application claims priority to German Application No. DE 10 2022 123 623.4, filed on Sep. 15, 2022, which applications are hereby incorporated herein by reference in their entireties.

### FIELD OF THE DISCLOSURE

The disclosure concerns a return device for returning and guiding at least one line, in particular on an articulated arm robot. The disclosure also concerns an articulated arm robot having such a return device.

### BACKGROUND

Articulated arm robots are used, for example, for guiding applicators for applying an application material onto components, such as e.g. motor vehicle bodies and/or attachment parts thereof. Such applicators are usually connected to lines, such as fluid lines and cables for energy and information transmission. The laying of the lines along the articulated arm robots poses a particular challenge. On the one hand, the lines should not result in a restriction of the flexibility of the articulated arm robots. On the other hand, the lines should not generate a significant interference contour at the articulated arm robots, in particular not at the robot hand sections.

Lines can be fixed to the articulated arm robots using e.g. collar clamps, clamps etc. However, here, problems are caused by the robot movements. In particular, the reason for this is that the lines have to perform compensatory movements as they cannot always be laid in the so-called neutral fiber. Depending on the robot position, at one time more or less line length is required for such compensating movements.

In a simple case, a necessary line length change can be enabled by providing a “loop”, which then closes (lengthens) or opens (shortens) depending on the robot position. However, this has the disadvantage that the line represents an unpredictable interference contour due to its undefined movement. In application processes with a defined working area, this can lead to an unintentional collision with the application component (e.g. a motor vehicle body).

Only one-dimensional guiding devices with only one-dimensional length compensation are often a compromise, as this usually results in high loads acting on the lines. A reason for this is in particular the limited ability to compensate for direction changes of the lines, as such guiding devices only act in one direction. This effects the life span of the lines negatively. In some cases, certain movement combinations of robot axes cannot even be implemented.

WO 2008 037 276 A1, for example, discloses a device for guiding a hose comprising at least one supply line, having a guiding element comprising at least three guiding rods, in which the hose is guidable against the return force of a return element, wherein end sides of the guiding element lying opposite one another in the longitudinal direction are formed by a front holding ring forming a hose inlet and a rear holding element, between which the guiding rods are clamped, and wherein a plurality of lateral outlet openings for the at least one supply line are formed between two adjacent guiding rods in each case. However, the device taught in WO 2008 037 276 A1 generates a relatively large interference contour, in particular at the robot hand section and at the robot arm carrying the robot hand section. In addition, the device is relatively complex in design and usually generates a relatively high tensile load on the hose. Furthermore, the device generates only a one-dimensional length compensation, which does not correspond to the movement possibilities of a modern articulated arm robot.

### BRIEF DESCRIPTION OF THE DRAWINGS

FIGS. 1 and 2 show different perspective views of a return device according to an embodiment of the disclosed technology,

FIG. 3 shows a perspective view of the return device, in particular for illustrating exemplary degrees of freedom of movement of the return device,

FIGS. 4A and 4B show highly schematic views of the return device, in particular for illustrating exemplary bending/transverse deformations of a return element of the return device,

FIGS. 5 and 6 show different perspective views of an articulated arm robot with a return device according to an embodiment of the disclosure, and

FIGS. 7 to 10 show different views of the articulated arm robot, in particular the return device.

The embodiments shown in the figures match in part, wherein similar or identical parts are provided with the same reference signs, and reference can also be made to the description of other embodiments for their explanation in order to avoid repetition.

### DETAILED DESCRIPTION

The disclosed technology provides an alternative and/or improved return device for returning and in particular guiding at least one line, a return device which is advantageously light-weight, comprises a low design complexity and/or enables an improved accessibility of an applicator with respect to an application component (e.g. motor vehicle body and/or attachment part therefor), in particular by minimizing an interference contour along a robot hand section and/or a robot arm, in particular on the robot hand side.

Advantageous further embodiments of the disclosure are disclosed in the dependent claims or result from the following description of various embodiments of the disclosure.

The disclosure concerns a return device for returning and guiding at least one line.

The return device comprises an elastic (elongated, e.g. rod-shaped) return element for returning the at least one line and e.g. for length compensation and/or for (multi-dimensional) direction compensation for the at least one line.

The return device also comprises a mounting device for (e.g. non-slidable and/or non-rotatable) mounting and, in particular, supporting the return element, at an articulated arm robot.

The return device also comprises a guiding device for guiding and (in particular at least sectionwise) accommodating the at least one line.

The mounting device can, for example, comprise a (flat or curved) mounting plate.

The guiding device can be, for example, toroidal and/or designed as a collar clamp construction.

The at least one line can be, for example, accommodated in the guiding device (in a backlash-free manner or in a backlash-subjected manner) and/or be guided through the guiding device (in a backlash-free manner or in a backlash-subjected manner).

The return device stands out in particular by the fact that the return element is designed as an elastic swing element (e.g. swing, pivot and/or bending arm).

The swing element can be designed to be in particular elastically (e.g. freely) swingable, bendable and/or pivotable, for example relative to the mounting device.

The return element can be elastically deformable in its longitudinal direction. Alternatively or additionally, the return element can be elastically deformable in its lateral direction, be freely deformable and/or movable in space in its lateral direction. The return element can thus be designed to be axially and/or laterally elastically deformable.

The mounting device can form a pivot base and the guiding device can form a guiding head that is swingable about the pivot base (in particular transversely and/or laterally to the longitudinal direction of the return element). The guiding head can, for example, be configured freely swingable, here.

In some embodiments, the return element is used for length compensation and/or for (e.g. lateral) direction compensation for the at least one line.

The guiding device can, for example, be designed as a guiding head and/or form a free end of the return device.

In some embodiments, the return element extends in particular axially between the mounting device and the guiding device and/or the mounting device and the guiding device are formed, and mounted, at opposite axial ends of the return element.

The elastic return element may, for example, comprise a base position (e.g. original shape) to which it strives to return and/or in which it extends substantially in a straight line. The return element can thus, for example, strive to return to the base position after a cancellation or reduction of a force subjection generated by the at least one line.

In some embodiments, the return element is configured to be freely swingable (e.g. transversely and/or laterally to the longitudinal direction of the return element).

In some embodiments, the return element, and thus the guiding device is configured to be freely swingable (in particular relative to the mounting device and/or elastically) and/or designed for multidimensional (in particular elastic) returning of the at least one line in several (in all three) spatial directions. Alternatively or additionally, the guiding device (in particular by the return element) can, for example, be freely movable in space, in particular elastically, and/or be movable in several (in all three) spatial directions, in particular elastically.

In some embodiments, the return element is a spring, e.g. a coil spring.

The spring can, for example, be designed as a compression and/or tension spring, e.g. as a compression and/or tension coil spring.

The return element can (in particular for returning the at least one line) be elastically deformable e.g. in its longitudinal and/or lateral direction.

In some embodiments, the guiding device is configured to guide the at least one line past the return element (in particular externally), transversely, in particular substantially orthogonally, past the return element. Thus, the return element can be arranged outside the at least one line, for example such that the at least one line does not extend, for example, into or through the return element and/or does not extend, for example, into or through the mounting device.

The guiding device can, for example, define a guiding axis (in particular a passage axis) for the at least one line, wherein the guiding axis can, for example, be oriented transversely, in particular substantially orthogonally, to the longitudinal axis of the return element.

The return element can, for example, be designed to be bent by the at least one line (in particular in several spatial directions, or in all three spatial directions) and thus be subjected to bending, so that, for example, a return force generated by bending can be generated transversely to the longitudinal extend of the return element. Alternatively or additionally, the return element can, for example, be designed to be pulled by the at least one line and thus subjected to tensile stress, so that, for example, a return force generated by tension can be generated in the longitudinal extend of the return element. Alternatively or additionally, the return element can, for example, be designed to be twisted by at least one line and thus subjected to torsion, so that, for example, a return force generated by torsion can be generated.

In some embodiments, all rotational movements, longitudinal movements and/or torsional movements of the at least one line can advantageously be enabled and, in particular, controlled exclusively by the return element. This is one of the main advantages of the return device.

The return element can be designed to be bent, in particular elastically, and/or laterally deflected elastically, e.g. by at least (or more than) 20°, 30°, 40°, 50°, 60°, 70°, 80°, 90°, 100°, 110°, 120°, 130°, 140°, 150°, 160°, 170°, 180°, 190° or 200°. In some embodiments, the return element allows to be elastically deformed at least up to a semicircular arc or beyond.

In some embodiments, the return element forms a cantilever arm supported at the mounting device and/or projects from the mounting device, e.g. in order to distance the guiding device and thus the at least one line from the mounting device and thus from the articulated arm robot by the longitudinal extend of the return element. Thereby, the return element can advantageously form a (sufficiently long) lever arm, for returning the at least one line and/or for distancing the at least one line from the mounting device and thus in particular from the articulated arm robot (e.g. the second robot arm described further below).

The return element can, for example, be elastically bendable transversely to the longitudinal axis of the return element and/or can be laterally elastically deflectable relative to the longitudinal axis of the return element. Alternatively or additionally, the guiding device can, for example, define a guiding axis for the at least one line, wherein the return element can be configured to be moved transversely, in particular substantially orthogonally, to the guiding axis of the guiding device (elastically).

The guiding device can, for example, be designed as a (open or closed) guiding ring. The ring can, for example, be designed in an openable and/or closable manner in order to be able to advantageously accommodate the at least one line.

The guiding device can, for example, be configured for (at least sectionwise) accommodating and/or guiding through the at least one line.

The at least one line can, for example, be accommodated in the guiding device in a backlash-free manner or with backlash and/or be guided through the guiding device.

In some embodiments, the guiding device is configured to accommodate and/or support the at least one line axially (in particular substantially freely) slidable and/or rotatable. This makes it possible, for example, that the at least one line can be axially displaced and/or rotated in the guiding device.

In some embodiments, the guiding device can thus be configured to limit movements of the at least one line only in radial direction of the at least one line (in a backlash-free manner or in a backlash-subjected manner), but to allow, for example, axial movements and/or rotational movements of the at least one line.

The return element can, for example, comprise a minimum length of substantially 15 cm, 20 cm, 25 cm, 30 cm or 35 cm.

The at least one line can comprise, for example, at least one fluid line for fluid transmission (e.g. for transmitting an application material and/or air, in particular compressed air) and/or at least one cable, in particular for energy and/or information transmission (e.g. a control cable, a grounding cable, a data cable and/or a cable for current transmission). The at least one line can, for example, be an application hose or comprise an application hose.

The at least one line can comprise, for example, a guiding hose (e.g. an envelope hose) and/or a guiding link chain, for accommodating at least one fluid line for fluid transmission (e.g. for transmitting an application material and/or air, in particular compressed air) and/or for accommodating at least one cable, for energy and/or information transmission (e.g. a control cable, an grounding cable, a data cable and/or a cable for current transmission).

The guiding hose can be designed as a corrugated hose, for example.

In some embodiments, the return element can be used for returning and, for example, for length compensation and/or for (multidimensional, in particular lateral) direction compensation for at least two in particular separate lines (e.g. guiding hoses and/or guiding link chains).

Embodiments with at least two (e.g. substantially parallelly or non-parallelly arranged) return devices as disclosed herein are also possible, the return elements of which may, for example, extend substantially parallelly or non-parallelly to each other.

It should be mentioned that the guiding device can be designed for accommodating and/or guiding-through the at least one line (in a backlash-free manner or in a backlash-subjected manner), for example such that the at least one line can be accommodated in the guiding device axially slidably and/or rotatably. However, embodiments are also possible in which the at least one line can be accommodated in the guiding device non-slidably and/or non-rotatably.

It should be mentioned again that the return element can be a swing element that is elastically deformable in its longitudinal and/or lateral direction. The return element can be an axially and/or laterally elastically deformable swing element.

The disclosure also concerns an articulated arm robot, for applying an application material to a component (e.g. a motor vehicle body and/or an attachment part therefor), having at least one return device as disclosed herein.

The articulated arm robot may comprise, for example, a robot base, a first (e.g. proximal and/or robot-base-close) robot arm, a second (e.g. distal and/or robot-base-remote) robot arm and, for example, a robot hand section.

The robot hand section can, for example, comprise at least two, three (in particular rotational) movement axes.

The articulated arm robot can, for example, comprise at least 4, at least 5 or at least 6 (rotational) movement axes.

In some embodiments, the return element projects from the articulated arm robot in order to distance the guiding device and thus the at least one line from the articulated arm robot by the longitudinal extend of the return element. Thereby, the return element can advantageously form a (sufficiently long) lever arm, for returning the at least one line and/or for distancing the at least one line from the mounting device and thus in particular from the articulated arm robot.

In some embodiments, the second robot arm is supported at the first robot arm by a robot hinge section pivotably about a movement axis, wherein the robot hinge section can be arranged between the first robot arm and the second robot arm.

The mounting device can, for example, be attached to the second robot arm and/or to the robot hinge section.

The mounting device and thus the return element can, for example, be pivotable with the second robot arm (about the movement axis of the second robot arm).

The return element can, for example, protrude from the second robot arm and/or from the robot hinge section, in particular in a cantilever arm shaped manner.

The return element may, for example, comprise a base position (in particular original shape) to which the return element strives to return. Alternatively or additionally, the return element can extend substantially in a straight line in the base position (in particular original shape).

The return element can thus, for example, strive to return to the base position after a cancellation or reduction of a force subjection generated by the at least one line.

In the base position, the guiding device can comprise, for example, a minimal distance to the articulated arm robot, in particular to the second robot arm and/or to the robot hinge section of at least 15 cm, 20 cm, 25 cm, 30 cm or 35 cm, in order to be able to form a sufficiently long lever arm.

In some embodiments, the return element (e.g. in the base position) is oriented transversely, substantially orthogonally, to the movement axis of the second robot arm, is oriented transversely, substantially orthogonally, to the longitudinal axis of the second robot arm, is oriented substantially parallel to the longitudinal axis of the first robot arm, and/or in particular is oriented away from the articulated arm robot (e.g. from the second robot arm and/or from the first robot arm) starting from the mounting device.

In some embodiments, the at least one line is guided past the return element by the guiding device (transversely, in particular substantially orthogonally), so that the at least one line, for example, does not extend into or through the return element and/or does not extend into or through the mounting device.

The at least one line can, for example, extend through the guiding device and/or be accommodated in the guiding device.

The at least one line can, for example, be guided into the guiding device in an arc-shaped manner and/or out of the guiding device in an arc-shaped manner.

The at least one line can be guided (e.g. substantially in an S-shaped manner) from the guiding device to the second robot arm and be fixed to the second robot arm.

The at least one line can, for example, be guided from the guiding device to the second robot arm substantially in an S-shaped manner. The S-shape can, for example, extend in two or three dimensions. The S-shape can therefore be flat or spatial, for example.

The return element can, for example, be designed to be elastically bent and/or laterally elastically deflected by, for example, at least (or more than) 20°, 30°, 40°, 50°, 60°, 70°, 80°, 90°, 100°, 110°, 120°, 130°, 140°, 150°, 160°, 170°, 180°, 190° or 200° during operation of the articulated arm robot., the return element can be elastically deformed at least up to a semicircular arc or beyond.

The return element can, for example, be designed, during operation of the articulated arm robot, to be bent transversely to the longitudinal axis of the second robot arm (in particular elastically) and/or to be bent transversely to the movement axis of the second robot arm (in particular elastically).

In some embodiments, movements of the robot hand section lead to the return element being bent in particular elastically and/or deflected laterally.

In some embodiments, a movement of the robot hand section acts on the return element, for example in the direction of the robot hand section, so that it is bent in the direction of the robot hand section, wherein alternatively or additionally a movement of the robot hand section can act on the return element, for example in a direction away from the robot hand section, so that it is bent in the direction away from the robot hand section.

In some embodiments, the at least one line is fixed to the second robot arm and/or to the robot hand section, in particular in order to advantageously reduce an interference contour of the articulated arm robot.

The at least one line can be fixed to the second robot arm e.g. by at least one holder (e.g. a toroidal guiding element, a clamp-and/or a collar clamp construction, etc.) axially slidably or non-slidably and/or rotatably or non-rotatably.

Alternatively or additionally, the at least one line can be fixed to the robot hand section by at least one holder (e.g. a toroidal guiding element, a clamp-and/or a collar clamp construction, etc.) axially slidably or non-slidably and/or rotatably or non-rotatably.

The second robot arm and/or the robot hand section can, for example, be movable relative to the guiding device, so that, for example, movements of the second robot arm and/or the robot hand section by the at least one line lead to deformations of the return element.

The first robot arm can, for example, be a proximal, in particular robot-base-close, robot arm and/or be pivotably supported at the robot base.

The second robot arm can, for example, be a distal, in particular robot-base-remote, robot arm and/or be pivotably supported at the first robot arm.

The second robot arm can carry the robot hand section.

The second robot arm is arranged between the first robot arm and the robot hand section.

In some embodiments, a clear distance between the at least one line and the second robot arm (e.g. along at least 30%, 40%, 50%, 60%, 70% or 80% of the longitudinal extend of the second robot arm) is smaller than 5 cm, 4 cm, 3 cm, 2 cm or 1 cm. Alternatively or additionally, a clear distance between the at least one line and the robot hand section (e.g. along at least 30%, 40%, 50%, 60%, 70% or 80% of the longitudinal extend of the robot hand section) may be smaller than 5 cm, 4 cm, 3 cm, 2 cm or 1 cm. The clear distance can, for example, be substantially 0 cm at least sectionwise.

The robot hand section can, for example, carry an applicator for applying an application material to a component (e.g. a motor vehicle body and/or an attachment part thereof).

In some embodiments, the at least one fluid line and/or the at least one cable is connected to the applicator.

It should be mentioned that the disclosure can be used for the interior application (e.g. interior painting, interior coating or interior sealing etc.) of motor vehicle bodies, in particular because of the low interference contour that can be advantageously achieved by the disclosure.

The application material can be, for example, a gloss paint, an adhesive, an insulant, a sealant or a primer, to name just a few examples.

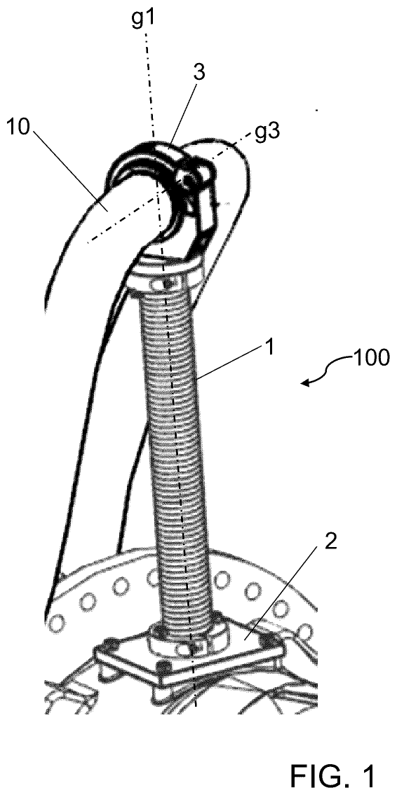

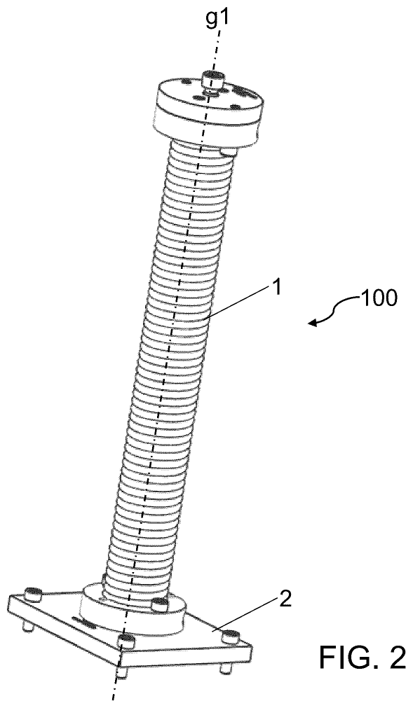

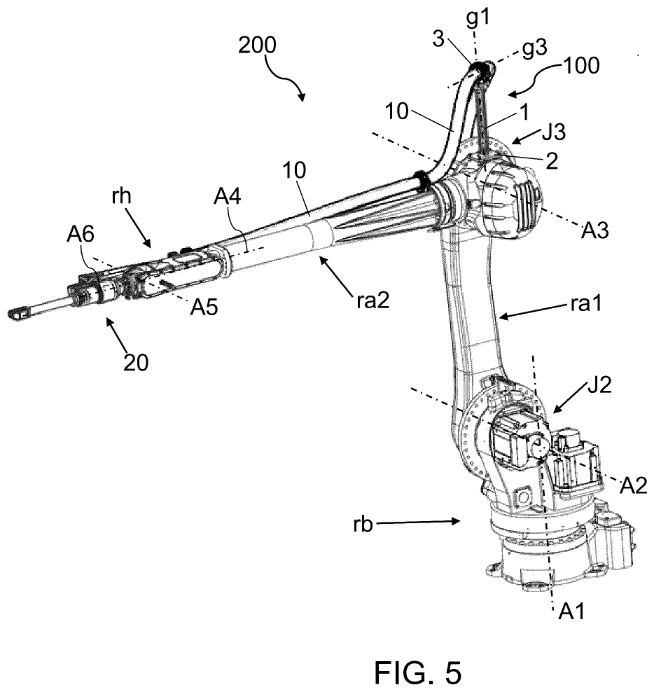

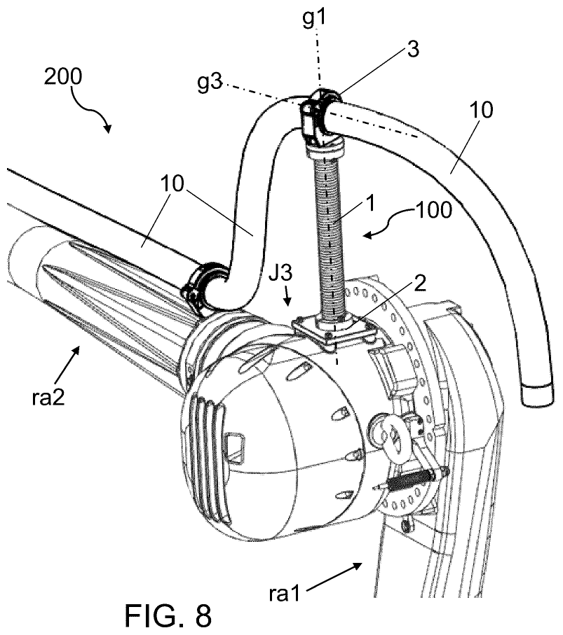

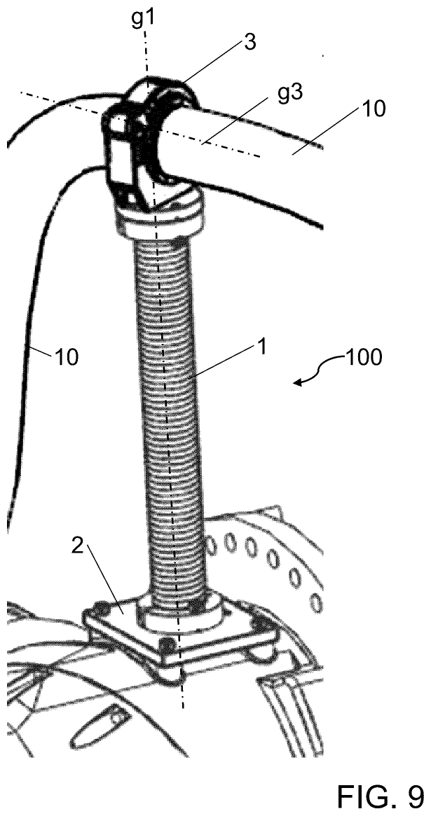

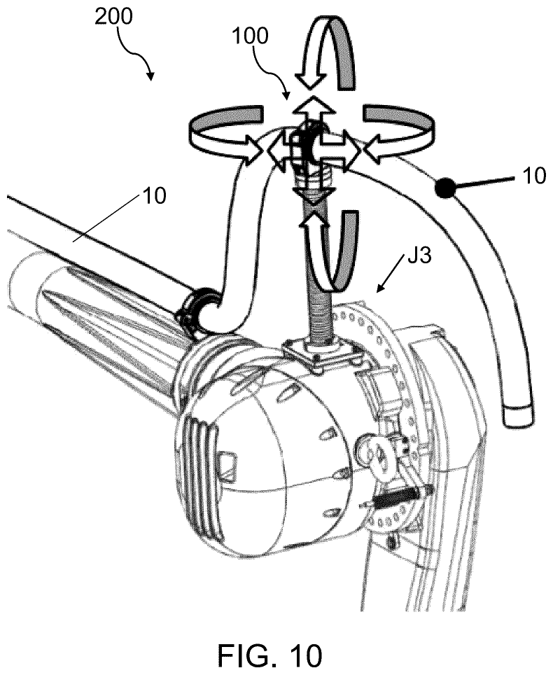

FIGS. 1 and 2 show different perspective views of a return device 100 for returning and guiding at least one line 10 according to an embodiment example of the disclosure. The return device 100 serves for use and mounting at an articulated arm robot 200 (e.g. FIGS. 5 to 10).

The line 10 can comprise, for example, a guiding hose (e.g. corrugated hose) and/or a guiding link chain, in particular for accommodating at least one fluid line for fluid transmission (e.g. application material, air, compressed air, etc.) and/or at least one cable for energy and/or information transmission (e.g. a power cable, a data cable, a control cable, an grounding cable, etc.).

The return device 100 comprises an elastic, elongate, return element 1 for returning the line 10 and a mounting device 2 for mounting and in particular supporting the return element 1, for example at the articulated arm robot 200.

The return device 100 also comprises a (e.g. toroidal) guiding device 3 for guiding and (e.g. backlash-free or backlash-subjected and in particular sectionwise) accommodating the line 10. The guiding device 3 is designed in particular for (e.g. backlash-free or backlash-subjected) guiding the line 10 through.

The guiding device 3 is configured to accommodate and/or support the line 10 axially freely slidably and/or rotatably, which can, for example, enable that the line 10 can be axially displaced and/or rotated in the guiding device 3. The guiding device 3 can thus be in particular configured to limit movements of the line 10 (only) in radial direction of the line 10 (in a backlash-free manner or in a backlash-subjected manner), but e.g. to allow axial movements and/or rotational movements of the line 10.

The line 10 can, for example, be fixed to at least one movement section (e.g. the second robot arm ra2 and/or the robot hand section rh, as shown, for example, in FIGS. 5 to 10), which is movable relative to the guiding device 3, so that movements of the movement section by the line 10 lead to deformations of the return element 1.

A special feature is that the return element 1 is designed as a axially and/or laterally elastically deformable swing element (e.g. swing, bending and/or pivot arm).

The return element 1 can, for example, be a spring, a coil spring, e.g. a compression and/or tension spring.

The guiding device 3 forms a free end of the return device 100. The return element 1 extends axially between the mounting device 2 and the guiding device 3, wherein the mounting device 2 and the guiding device 3 are formed at opposite axial ends of the return element 1. The return element 1 protrudes from the mounting device 2, in particular in a cantilever arm shaped manner, in order to distance the guiding device 3 and thus, the line 10 from the mounting device 2 and thus, for example, from the articulated arm robot 200 by the longitudinal extend of the return element 1.

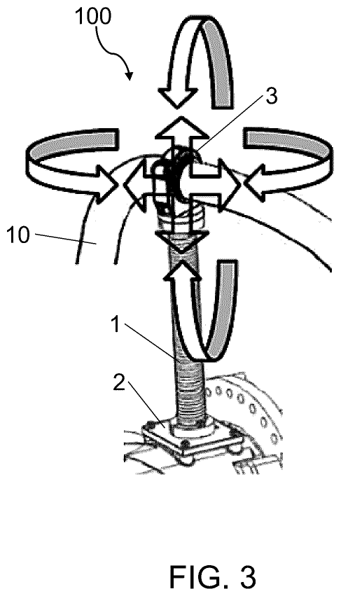

FIG. 3 shows a perspective view of the return device 100, in particular for illustrating exemplary degrees of freedom of movement of the return device 100. The degrees of freedom of movement are schematically indicated by the arrows in FIG. 3.

FIGS. 1 to 3 show the return element 1 in an exemplary base position (in particular original form). In the base position, the return element 1 extends substantially in a straight line. The return element 1 strives to return to the base position, in particular after a cancellation or reduction of a force subjection generated by the line 10.

A special feature is that the return element 1 is configured to be freely swingable and/or designed for multidimensional returning of the line 10 in several spatial directions, in all three spatial directions, which is shown in particular in FIG. 3. The return element 1 thus advantageously serves not only for one-dimensional length compensation, but also for length compensation and for (multidimensional, in particular lateral) direction compensation for the line 10. The guiding device 3 can be freely movable in space and/or in several (e.g. all three) spatial directions, in particular elastically movable, by the return element 1. In particular, the return element 1 is elastically bendable transversely to its longitudinal axis g1 and/or laterally elastically deflectable.

In some embodiments, all rotational, longitudinal and torsional movements of the line 10 can advantageously be enabled and controlled exclusively by the return element 1. This is one of the main advantages of the return device 100.

The return element 1 can form a cantilever arm supported at the mounting device 2 and project from the mounting device 2 in order to distance the guiding device 3 from the mounting device 2 by the longitudinal extend of the return element 1.

The guiding device 3 can, for example, define a guiding axis g3 for the line 10, wherein the guiding axis g3 can be oriented transversely, in particular substantially orthogonally, to the longitudinal axis g1 of the return element 1. In particular, the return element 1 can be designed to be elastically deformed transversely, in particular substantially orthogonally, to the guiding axis g3 of the guiding device 3.

The guiding device 3 can thus be configured, for example, to guide the line 10 past the return element 1, transversely, in particular substantially orthogonally, so that the line 10 does not extend, for example, into or through the return element 1 and/or does not extend into or through the mounting device 2.

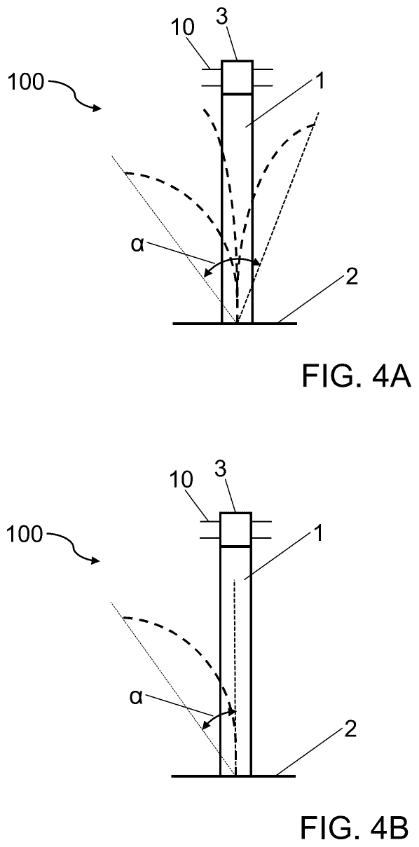

FIGS. 4A and 4B show highly schematic views of the return device 100, in particular for illustrating exemplary bending deformations (e.g. transverse deformations) of the return element 1 that can be generated by the line 10. The bending deformations are schematically indicated by dashed lines in FIGS. 4A and 4B.

FIGS. 4A and 4B show, for example, that the return element 1 forms an in particular elastic cantilever arm and is configured to be freely swingable, in particular such that the return element 1 can be bent out of the base position by the line 10 and can thus be subjected to bending stress and/or can be pulled at least slightly and can thus be subjected at least slightly to tensile stress. In some embodiments, the return element 1 can be e.g. at least slightly twisted by the line 10 and thus subjected to torsion.

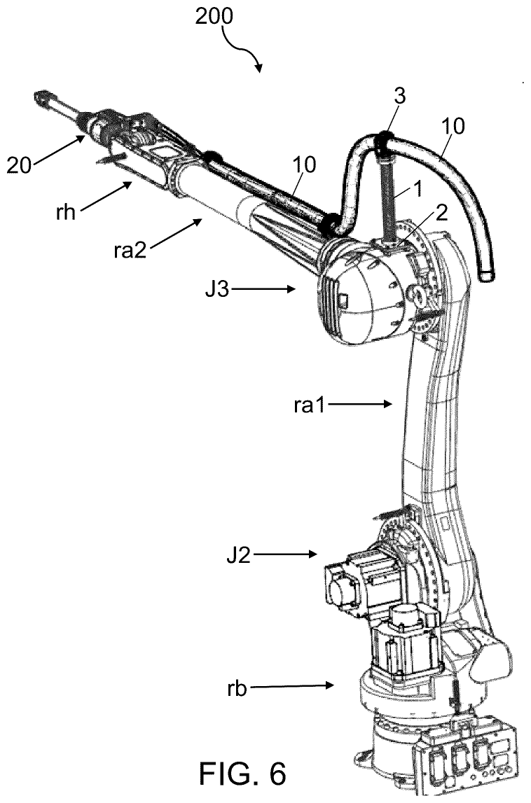

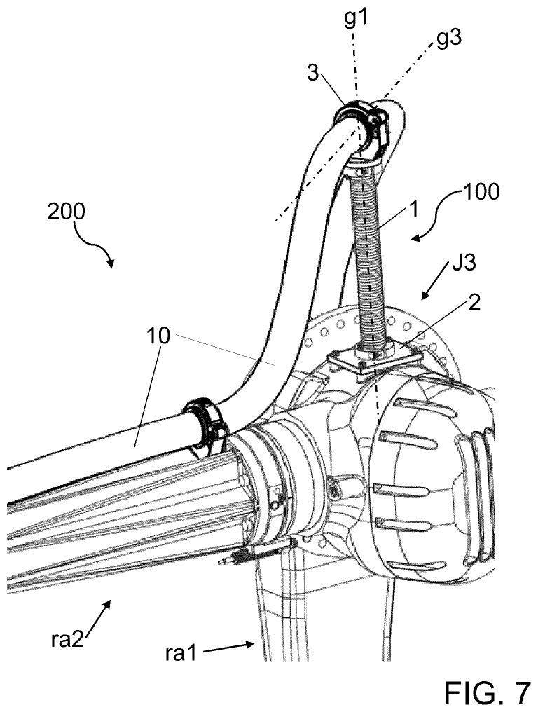

FIGS. 5 and 6 show different perspective views of an exemplary articulated arm robot 200 with a return device 100 according to an embodiment of the disclosure, wherein FIGS. 7 to 10 show associated detailed views. The articulated arm robot 200 may, for example, be a conventional articulated arm robot.

The articulated arm robot 200 comprises a robot base rb, a first pivotable robot arm ra1, a second pivotable robot arm ra2 and a robot hand section rh.

The first robot arm ra1 is a proximal and/or robot base-close robot arm.

The second robot arm ra2 is a distal and/or robot base-remote robot arm. The second robot arm ra2 is arranged between the first robot arm ra1 and the robot hand section rh.

The robot base rb can be rotatable about a movement axis A1.

The first robot arm ra1 can be supported at the robot base rb by a robot hinge section J2 pivotably about a movement axis A2.

The second robot arm ra2 can be supported at the first robot arm ra1 by a robot hinge section J3 pivotably about a movement axis A3.

The robot hand section rh can comprise several movement axes, three axes of rotation A4, A5 and A6.

The robot hand section rh can, for example, carry an applicator for applying an application material to a component (e.g. a motor vehicle body and/or an attachment part thereof).

The axes A1, A2, A3, A4, A5 and/or A6 are rotary axes.

The line 10 can be accommodated axially slidable by the guiding device 3. However, embodiments are also possible, in which the line 10 can be accommodated in the guiding device 3 non-slidably.

The line 10 can be accommodated by the guiding device 3, e.g. non-rotatably or rotatably.

The line 10 can be fixed to the second robot arm ra2 and/or to the robot hand section rh.

The line 10 can, for example, be fixed to the second robot arm ra2 axially freely slidably or non-slidably and/or rotatably or non-rotatably by at least one holder.

The line 10 can, for example, be fixed to the robot hand section rh by at least one holder axially freely slidably or non-slidably and/or rotatably or non-rotatably.

The second robot arm ra2 and/or the robot hand section rh is movable relative to the guiding device 3. Thus, movements of the second robot arm ra2 and/or the robot hand section rh by the line 10 lead in particular to elastic deformations of the return element 1, forcing the return element 1 to leave its (substantially rectilinear) base position.

The return element 1 protrudes from the articulated arm robot 200 (from the second robot arm ra2 and/or from the robot hinge section J3) and is configured to distance the guiding device 3 and thus the line 10 from the mounting device 2 and thus from the articulated arm robot 200 by the longitudinal extend of the return element 1. The return element 1 can form an sufficiently long lever arm, in particular for returning the line 10 and for distancing the line 10 from the mounting device 2 and thus from the articulated arm robot 200. The lever arm enables an sufficiently large length-and direction compensation for the line 10.

The line 10 can be guided past the return element 1 by the guiding device 3, transversely, in particular substantially orthogonally, so that, for example, the line 10 does not extend into or through the return element 1 and/or does not extend into or through the mounting device 2.

The line 10 can extend, in particular, through the guiding device 3 and can be accommodated in the guiding device 3.

The line 10 can, for example, be guided into the guiding device 3 in an arc-shaped manner and out of the guiding device 3 in an arc-shaped manner.

The line 10 can be guided from the guiding device 3 to the second robot arm ra2 and/or to the robot hand section rh. In some embodiments, the line 10 can be guided from the guiding device 3, for example, in a two-or three-dimensional, substantially S-shaped manner to the second robot arm ra2, as shown, for example, in FIG. 6.

One advantage that can be achieved by the return device 100 is, for example, that the line 10 can be guided at least close-fittingly in sections along the second robot arm ra2 and/or along the robot hand section rh in direction of an applicator 20 for applying an application material to a component, whereby an interference contour can be advantageously reduced in the surrounding area of the applicator 20. The disclosure can thus be used to particular advantage in the interior application (e.g. interior painting, interior coating or interior sealing, etc.) of motor vehicle bodies.

In some embodiments, a clear distance between the line 10 and the second robot arm ra2 (e.g. along at least 30%, 40%, 50%, 60% or 70% of the longitudinal extend of the second robot arm ra2) is smaller than 5 cm, 4 cm, 3 cm, 2 cm or 1 cm, and/or a clear distance between the line 10 and the robot hand section rh (e.g. along at least 30%, 40%, 50%, 60% or 70% of the longitudinal extend of the robot hand section rh) is smaller than 5 cm, 4 cm, 3 cm, 2 cm or 1 cm. The clear distance can, for example, be substantially 0 cm at least sectionwise.

The return element 1 can e.g. be configured to be, during operation of the articulated arm robot 200 (e.g. by movements of the robot hand section rh around the movement axis A4, A5 and/or A6) elastically laterally deflected and thus bent by a deflection angle (z. B pivot angle) α of at least 20°, 30°, 40°, 50°, 60°, 70°, 80°, 90°, 100°, 110°, 120°, 130°, 140°, 150°, 160°, 170°, 180°, 190° or 200°, as shown, for example, in FIGS. 4A and 4B.

In FIG. 4A, for example, the deflection angle a is at least approximately 60°.

In FIG. 4B, for example, the deflection angle a is at least approximately 35°.

If necessary, however, the return element 1 can also be deformed elastically, e.g. up to a semicircular arc, i.e. a deflection angle a of substantially 180°, or beyond.

In particular, a movement of the robot hand section rh can act on the return element 1, e.g. in the direction of the robot hand section rh.

The guiding device 3 and thus the line 10 can move substantially without restriction in three-dimensional space, which advantageously exerts the lowest possible load on the line 10.

This advantageously enables complex movement sequences, e.g. of the articulated arm robot 200.

The line 10 always behaves in a predictable manner, which can make programming the articulated arm robot 200, for example, much easier.

A positive consequence of this is, for example, the reduction of collisions between the line 10 and the application component (e.g. vehicle body and/or attachment part therefor). Last but not least, this is also made possible by the advantageously realizable close-fitting line routing, especially in the area of the second robot arm ra2.

The use of a separate, one-dimensional guiding system is not necessary due to the freely swinging return element 1, which in turn has the advantage of low complexity due to fewer individual components.

Overall, the robot interference contour can be advantageously decisively reduced by the return device 100, which optimizes the accessibility of the articulated arm robot 200, e.g. with respect to the application component.

Another advantage that should not be underestimated is the reduced weight load for the articulated arm robot 200 made possible by the return device 100. This reduces the load on the overall system, which has a positive effect on the life span.

The small number of individual components of the return device 100 also advantageously reduces the costs for the initial equipment as well as for maintenance.

By the disclosure, for example, at least one of the following advantages can be achieved:
1. The return element 1 and thus the line 10 (e.g. a media guiding) can move (in particular elastically) in 3 dimensions.
2. Lowest possible load on the line 10.
3. Complex movement sequences of an articulated arm robot 200 can be implemented in conjunction with the line 10.
4. The line 10 behaves predictably, which makes the programming of the articulated arm robot 200 easier, for example.
5. Reduction or avoidance of collisions between the line 10 and an application component (e.g. motor vehicle body and/or attachment part therefor).
6. A separate, one-dimensional guiding system is not required.
7. Low complexity due to only a few individual components of the returning device 100.
8. Reduced additional weight load for the articulated arm robot 200.
9. Close-fitting guiding of the line 10, in particular along the second robot arm ra2.
10. Minimizing the interference contour through the line 10 and thus reducing the robot interference contour.
11. Optimized accessibility of the articulated arm robot 200, in particular the applicator 20, with respect to an application component (e.g. motor vehicle body and/or attachment part therefor).
12. Cost reduction for original equipment and maintenance.

The disclosure is not limited to the embodiments described above. Rather, a large number of variants, combinations, and modifications are possible which also make use of the disclosed technology and therefore fall within the scope of the disclosure.

1-27. (canceled)

28. A return device for returning at least one line, comprising:
an elongated return element for returning the at least one line;
a mounting device for mounting the return element on an articulated arm robot; and
a guiding device for guiding the at least one line;
wherein the return element is designed as an elastic swing element.

29. The return device according to claim 28, wherein the return element serves for length compensation and for lateral direction compensation for the at least one line.

30. The return device according to claim 28, wherein the guiding device forms a free end of the return device.

31. The return device according to claim 28, wherein the return element extends axially between the mounting device and the guiding device and the mounting device and the guiding device are formed at opposite axial ends of the return element.

32. The return device according claim 28, wherein the return element is configured to be freely swingable; is configured for multidimensional elastic returning of the at least one line in all three spatial directions; and is deformable elastically in its longitudinal and lateral direction.

33. The return device according to claim 28, wherein the guiding device is freely movable elastically in space relative to the mounting device by way of the return element.

34. The return device according to claim 28, wherein the return element is a coil spring.

35. The return device according to claim 28, wherein the guiding device is configured to guide the at least one line transversely past the return element, and defines a guiding axis for the at least one line and the guiding axis is oriented transversely to the longitudinal axis of the return element.

36. The return device according to claim 28, wherein the return element is configured to be bent, pulled and twisted by the at least one line.

37. The return device according to claim 28, wherein the return element forms a cantilever arm supported at the mounting device and projects away from the mounting device in order to distance the guiding device from the mounting device by way of the longitudinal extend of the return element and in order to form a lever arm for returning the at least one line by way of the longitudinal extend of the return element.

38. The return device according to claim 28, wherein
the return element is elastically bendable transversely to its longitudinal axis and laterally elastically deflectable relative to its longitudinal axis, and
the guiding device defines a guiding axis for the at least one line and the return element is configured to be moved transversely, in particular substantially orthogonally, to the guiding axis of the guiding device.

39. The return device according to claim 28, wherein the at least one line comprises a guiding hose and a guiding link chain, in particular for accommodating at least one fluid line for fluid transmission and at least one cable for energy and information transmission.

40. An articulated arm robot, comprising:
a robot base;
a first pivotable robot arm;
a second pivotable robot arm;
preferably a robot hand section; and
at least one return device, including:
an elongated return element for returning the at least one line;
a mounting device for mounting the return element on an articulated arm robot; and
a guiding device for guiding the at least one line;
wherein the return element is designed as an elastic swing element.

41. The articulated arm robot according to claim 40, wherein the return element projects from the articulated arm robot in order to distance the guiding device and thus the at least one line from the articulated arm robot by way of the longitudinal extend of the return element and in order to form a lever arm for returning the at least one line by the longitudinal extend of the return element.

42. The articulated arm robot according to claim 40, wherein the second robot arm is supported pivotably about a movement axis at the first robot arm by a robot hinge section.

43. The articulated arm robot according to claim 42, wherein the mounting device is attached to the second robot arm and to the robot hinge section.

44. The articulated arm robot according to claim 40, wherein the mounting device and thus the return element is pivotable with the second robot arm.

45. The articulated arm robot according to claim 40, wherein the return element comprises a base position to which it strives to return and in which it extends substantially in a straight line.

46. The articulated arm robot according to claim 40, wherein the return element, preferably in the base position,
is oriented transversely, preferably substantially orthogonally, to a movement axis of the second robot arm,
is oriented transversely, preferably substantially orthogonally, to a longitudinal axis of the second robot arm,
is oriented substantially parallel to a longitudinal axis of the first robot arm, and
is oriented away from the articulated arm robot starting from the mounting device.

47. The articulated arm robot according to claim 40, wherein the at least one line is fixed to the second robot arm and to the robot hand section and preferably the second robot arm and the robot hand section is movable relative to the guiding device.
